(19) United States
(12) Patent Application Publication
(10) Pub. No.: US 2002/0172214 A1
(43) Pub. Date: Nov. 21, 2002

(54) DOUBLE BREAST MODEL IN SHAPE OF FOOTBALL AND METHOD OF USING SAME

(76) Inventor: Raymond Doyle Grantham, San Angelo, TX (US)

Correspondence Address: RAYMOND DOYLE GRANTHAM, 2520 WEST BEAUREGARD AVE., SAN ANGELO, TX, 76901, US

(21) Appl. No.: 09/858,014

(22) Filed: May 16, 2001

(51) Int. Cl. H04L 12/28

(52) U.S. Cl. 370/431; 370/406

(57) ABSTRACT

A double breast model comprising breasts arranged with a nipple (28) and its areola (27) on each end with the backs of the breasts joined in a continuous configuration to form a shape similar to a rugby ball or football. The double breast model of this invention incorporates a method of tumor detection training through simultaneous comparison of tactile sensations experienced on the respective ends of the same device by the left and right hands. In addition, the double breast model's unique and aesthetically pleasing shape can be used as a sport ball and promotional device to enhance awareness of breast cancer.

### BACKGROUND

1. Field of invention

This invention relates to models of the human female breast, which are used to instruct women in methods of breast self-examination, and is also useful for training medical and health professionals in palpation techniques. Its unique shape also serves as a novelty and promotional item.

2. Description of Prior Art

Malignant tumors of the breast are the leading cause of cancer death among women in the United States. Early detection of the tumors is the most important factor contributing to successful treatment and cure of these cancers.

Since over ninety five percent of breast cancers are potentially palpable, manual self-examination techniques are the most important defense against their development toward more advanced cancers. Manual palpation is the only examination method that does not require the involvement of medically trained personnel, which makes it inexpensive.

Manual palpation does not require the unnecessary invasion of body tissue by radiation, heat, high intensity sound waves or tissue removal for biopsy.

U.S. Pat. No. 4,134,218 of Adams, et al. discloses a device and method whereby individuals are trained to palpate tumors in a single breast model that involves the use of complicated electronic pressure sensing equipment. The use and production of this device and its electronics is costly and cumbersome, making its use by the untrained individual impractical. Palpation with the right and left hands respectively on a breast model, for simultaneous comparison purposes, would require the purchase of two Adams models. The Adams model with its attached electronics is unsuitable for use outside the clinical setting.

U.S. Pat. No. 4,867,686 of Goldstein discloses a device that requires a visual verification of palpation results rather than simultaneous tactile comparison on the same device. Again, as noted with the Adams model above, the added expense of purchasing two devices for simultaneous tactile comparison is necessary and it is intended mainly for use as a clinical teaching model.

U.S. Pat. No. 4,364,880 of Howse describes a method for making a breast prosthesis that can also be used for teaching breast self-examination. The Howse embodiment is recommended as a backboard mounted device for an instructor's use in training the patient to learn breast self-examination. While this device is suggested with multiple single breast models for possible use in professional training of individuals in the art of palpation, there is no mention of a double breast model. As mentioned with the Adams and Goldstein models the Howse model is meant for use in a clinical setting with professional instruction.

U.S. Pat. No. 5,171,321 of Davis discloses a prosthetic model for application to the exterior of a human breast for cosmetic and novelty purposes. The Davis patent depicts a realistic appearance and feel to the model but is unsuited for use as a tumor detection device because of its concave shaped interior which leaves no defined area in which a simulated tumor can be disposed.

U.S. Pat. No. 4,737,109 of Abramson discloses a model mounted to a pair of boards that are hinged to allow placement and removal of lesions and simulated tumors within the device. While this device can be instructive, it requires the assistance of another individual to verify results. This model does not allow simultaneous palpation with both hands to facilitate a comparison between the feel of the density, fluidity and relative hardness of a tumor to a tumor-free sensation as can be produced on the opposite end of a double breast model.

While hundreds of patents exist in the prior art for realistic breast prosthesis construction, they are used to replace the missing body part or as a breast implant device. None of the prosthesis patents address their use as a tumor detection-training device or system for teaching breast self-examination in the home. Also, none of the patents in the prior art referred to a double breast model or suggest a configuration other than the single breast model.

There is no theme in the prior art that suggests the importance of teaching breast self-examination at an early age without the instruction of a doctor or healthcare professional. In a woman's younger years there are few visits to a doctor who would teach the necessary techniques of breast self-examination due to the overall good health and vitality of youth.

### SUMMARY

In accordance with the present invention a double breast model with a resemblance to a football or rugby ball.

### OBJECTS AND ADVANTAGES

In view of the prior art's limitations and disadvantages it becomes apparent that there exists a need for a model with the following objects and advantages:

(a) to provide an inexpensive double breast model with a novel football-like shape for promoting breast self-examination outside the doctor's office;

(b) to provide a convenient compact double breast model which can be used for simultaneous tactile comparison with both hands on opposite ends of the same device;

(c) to provide a double breast model that can display breasts of different skin colors as they exist in nature on opposite ends of a single device;

(d) to provide a double breast model that can display the various combinations of nipple size to areola size as they exist in nature on opposite ends of the same device;

(e) to provide a double breast model that can contain various combinations of tumor sizes and densities, or lack thereof, disposed on opposite ends of the same device;

(f) to provide an inexpensive double breast model with multiple uses, through various embodiments, as a sport ball, tumor detection-training device, novelty or promotional item; and

(g) to provide an inexpensive double breast model that can be used in the field of sex education in a less formal, less embarrassing way due to its rugby ball or football-like shape.

Through consideration of the following drawings and ensuing description, further objects and advantages will become apparent.

### DRAWING FIGURES

FIG. 1 shows a three dimensional view of the double breast model depicting its football-like shape.

FIG. 2 shows a cross sectional view of the double breast model with a medium density tumor disposed on one end.

FIG. 3 shows a cross sectional view of the double breast model with a plurality of tumors 23, 24, 25, 26, comprising various types, densities and hardness disposed on either end.

FIG. 4 shows a cross sectional view of the double breast model with a round semi-rigid core area and a medium density tumor disposed on one end.

FIG. 5 shows a cross sectional view of the double breast model with a round semi-rigid core area and a plurality of tumors with various types, densities and hardness disposed on both ends.

FIG. 6 shows a cross sectional view of the double breast model with an oblong semi-rigid core are and a medium density tumor disposed on one end.

FIG. 7 shows a cross sectional view of the double breast model with the majority of the interior composed of the semi-rigid core material.

### REFERENCE NUMERALS IN DRAWINGS

20 simulated skin

21 simulated adipose tissue

22 semi-rigid core area

23 medium density tumor

24 softer less dense tumor

25 tumor on or near surface of skin

26 small dense tumor

27 areola

28 nipple

29 separate flexible enclosure

### DESCRIPTION

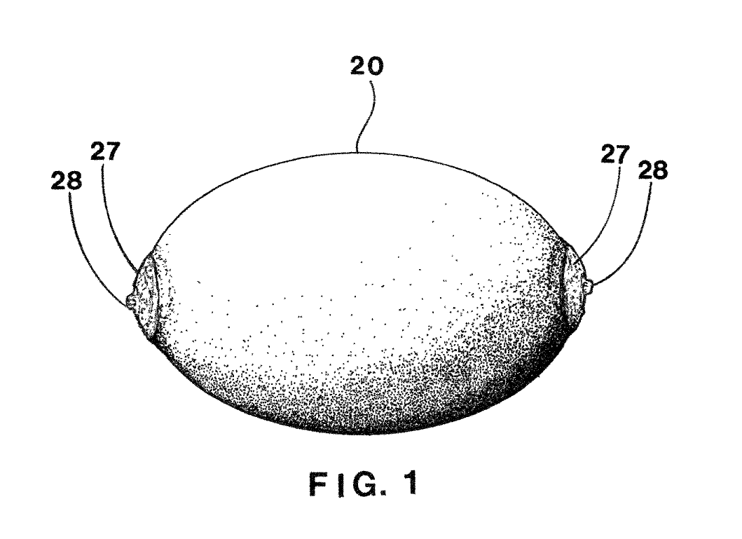

### FIGS. 1-7

FIG. 1 shows a typical embodiment of the present invention comprising simulated skin 20 of the color desired and an areola 27 with nipple 28 approximately centered therein on both ends of the model. The simulated skin can be constructed of polyvinylchloride, polyurethane, latex rubber, polypropylene, silicone resin polymers or any fabric material that can impart a natural skin feel when applied over the simulated adipose tissue 21.

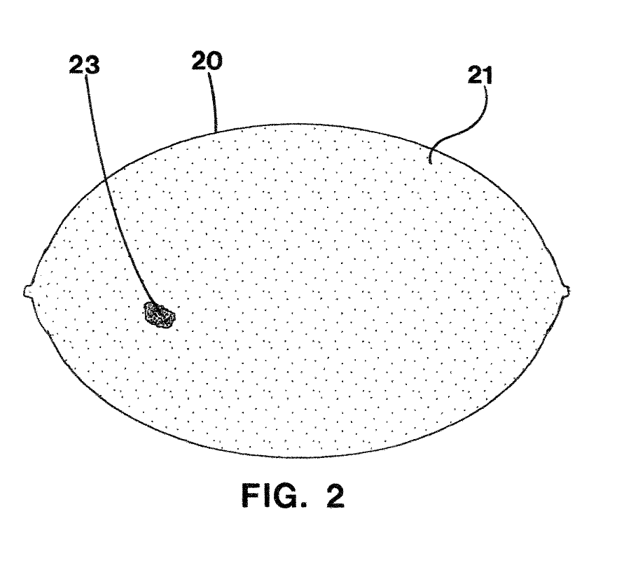

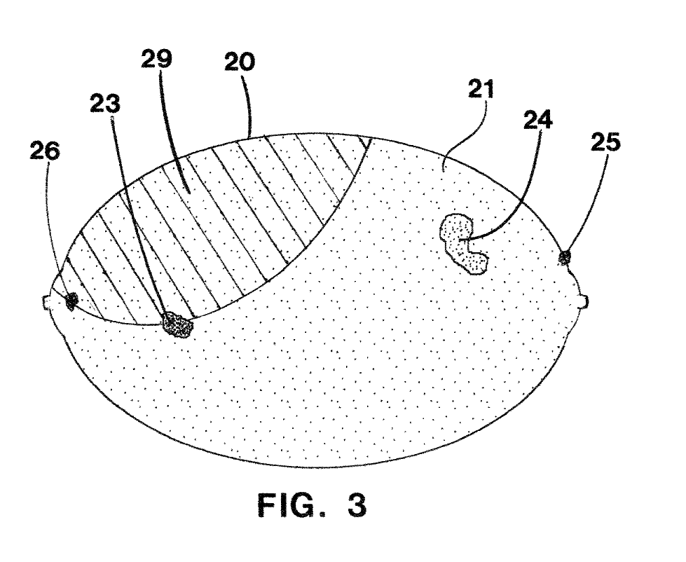

FIG. 2 is a cross section of the model depicting a medium density tumor 23 suspended in the simulated adipose tissue 21. The simulated adipose tissue 21 in FIG. 2 would be comprised of any of the polymers used to form the simulated skin material provided they are capable of achieving the density and resilience necessary to mimic the natural tissue and must be chemically compatible with the skin material. A soft polyvinylchloride polymer, such as that commonly available through major fishing tackle outlets for the purpose of making soft plastic lures, readily lends itself to molding and coloration. The polyvinylchloride polymer is easy to manipulate in density, hardness or softness by adding softening or hardening agents that are readily acquired from the same sources offering the polyvinylchloride polymer. In double breast models containing simulated adipose tissue 21 made from polyvinylchloride the model would display resilient properties. In addition, soft foam rubber, an aqueous or vegetable oil solution, or any of the currently available silicone gels produced by companies like Dow Corning Corporation or General Electric Company for the purpose of making breast implants would be acceptable. The medium density tumor 23 can be constructed from any of the elastomeric polymers wherein the density or hardness can be controlled through the use of various catalysts, plasticizers, softening and hardening agents, However the polymer chosen must be chemically compatible with the material it is in contact with. In the FIG. 2 embodiment, as well as in FIG. 3, the simulated adipose tissue 21 comprises a homogeneous mixture throughout the interior portion of the model.

The tumor suspension process may require the incorporation of fine diameter spun polyester anchor filament as an integral part of the tumor if the simulated adipose tissue 21 is made from a substance that demonstrates a high viscosity without a great degree of resilience. This would be the case with embodiments where the aqueous and vegetable oil solutions are used to form the simulated adipose tissue 21. These fine spun polyester filaments are currently manufactured for use as ultra fine fishing line in the 6, and 8-pound test category and are marketed under trade names Spectra® and Micro-Dyneema®. Such filament is unnoticeable to the touch through the simulated skin 20.

When constructed from methods utilizing resilient materials such as soft foam rubber or soft polyvinylchloride, the double breast models depicted in FIGS. 2 and 3 are easily and economically formed and the simulated tumors 23, 24, 25, 26 are easily molded into position. The center regions of the FIG. 2 and 3 models can be made of a harder, denser version of the same polymer used to form the surrounding simulated adipose tissue 21 to replicate the underlying muscle and skeletal tissue.

A simulated tumor 23, 24, 25, 26 with its embedded filament could be anchored within a separate flexible enclosure 29 filled with a simulated adipose tissue of a like viscosity or resilience to that of the surrounding simulated adipose tissue 21. Simulated tumors 23, 24, 25, 26 can also be mounted on the surface of the separate flexible enclosure 29, which would be incorporated within the interior of the model. The size and shape of the separate flexible enclosure 29 would vary according to the desire to locate the simulated tumor in a deep, slow, high or low position. Simulated tumors 23, 24, 25, 26 mounted within the simulated adipose tissue 21 comprised of resilient material, in which no fluidity exists, will require only to be molded in at the desired locations.

The model in FIG. 3 shows a cross sectional view of a plurality of tumors 23, 24, 25, 26 comprised of various types, densities and hardness disposed on either end of the model. As with the construction of the medium density tumor 23, the softer tumor 24 can be formed by the same processes wherein the materials will allow the formation of the softer substance and maintain compatibility with surrounding materials. In some cases it may be desired to have the softer tumor 24 encapsulated in an elastomeric enclosure which will allow a fluid movement within such an enclosure to closely simulate the natural feel of some soft tumors. The tumor 25 on or near the surface of the skin can be made by any of the processes mentioned above and fastened to the skin surface. If desired, tumor 25 and the small dense tumor 26 can be simulated by using a hard object such as a glass bead, small rock or steel object of suitable size and shape. Also in the FIG. 3 cross sectional view, tumors 23 and 26 are mounted on the surface of the separate flexible enclosure 29.

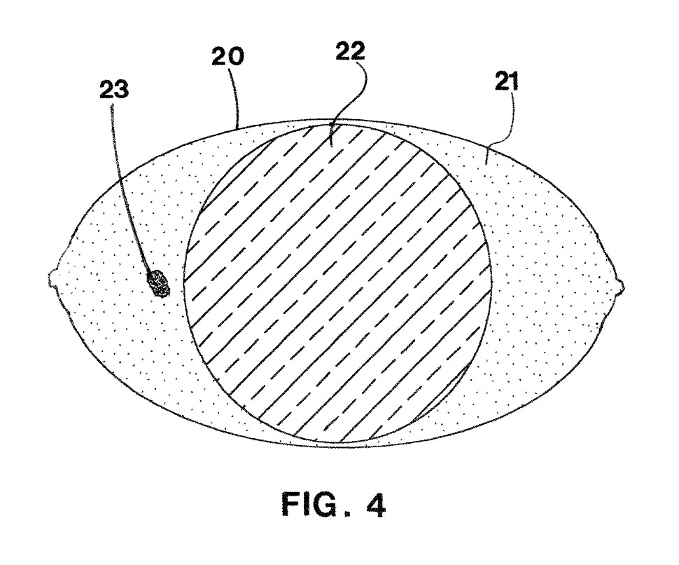

The breast model cross sectional view in FIG. 4 shows a circular semi-rigid core area 22 which may consist of materials from soft wood, polyisocyanurate foam, dense foam rubber to an air bladder like that contained in many common sport balls. If desired, the construction of the semi-rigid core area 22 can be comprised of any combination of hard and soft materials to achieve the desired result necessary for the particular embodiment. Although not shown, a tumor 23, 24, 25, 26 can be mounted on the surface of the semi-rigid core area 22. A medium density tumor 23 is disposed within the simulated adipose tissue 21 on one end of the FIG. 4 model.

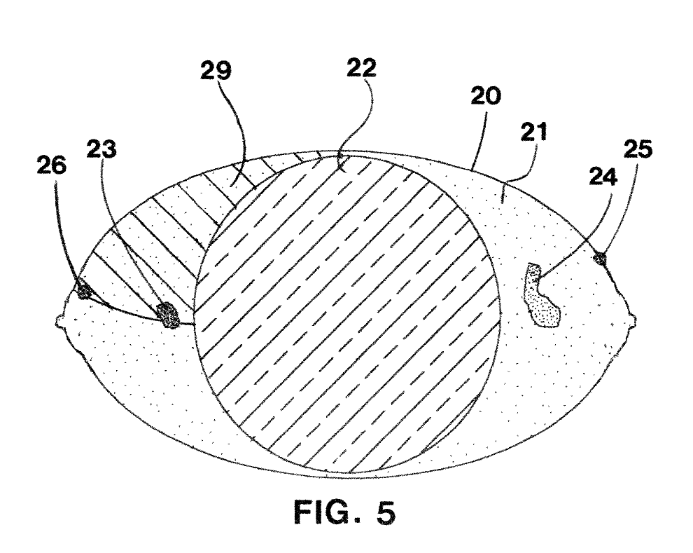

FIG. 5 is a cross sectional view depicting a circular semi-rigid core area 22 with a plurality of simulated tumors 23, 24, 25, 26 disposed within the simulated adipose tissue 21 on both ends of the double breast model. Simulated tumors 23 and 26 are shown mounted to the surface of a separate flexible enclosure 29.

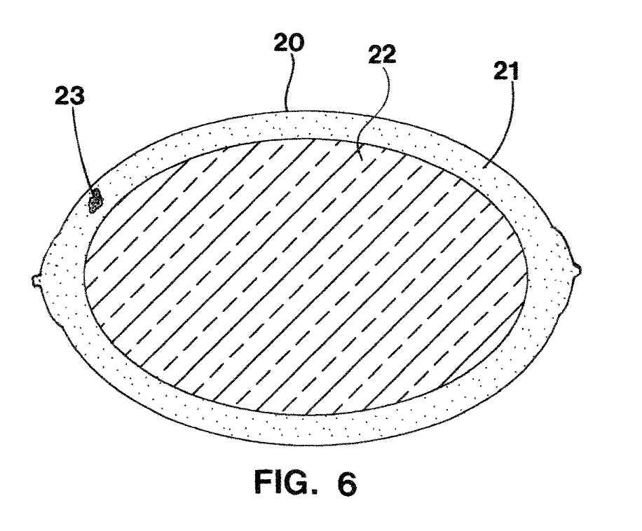

In the FIG. 6 cross sectional view, the semi-rigid core area 22 is shown in a larger elongated shape that leaves a smaller area to fill with the simulated adipose tissue 21. A single simulated medium density tumor 23 is disposed on one end, The simulated adipose tissue 21 in this embodiment may exist as a loose, unwoven resilient fiber-fit material such as polyester. The simulated skin 20 would hold or compress the fiber-fill material.

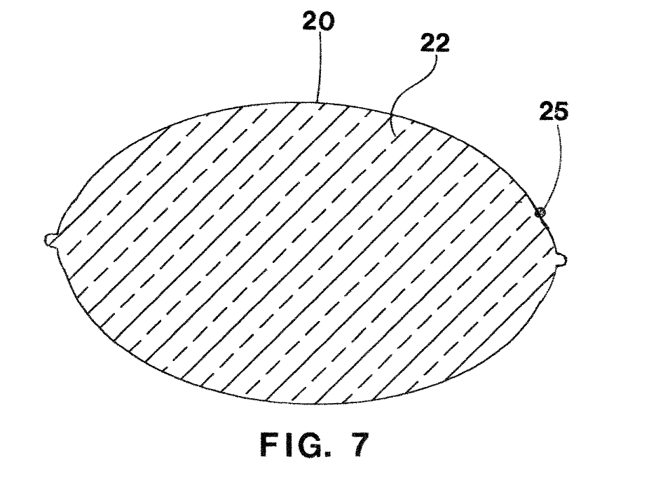

The FIG. 7 cross sectional view shows the semi-rigid core area 22 occupying virtually all the interior space and having the simulated skin 20 covering the exterior. This cross sectional view can also represent an embodiment in which the simulated skin 20 is made of a material that serves as an air bladder capable of holding pressure to maintain its desired shape. In still another embodiment, the simulated skin 20 can be constructed of a harder, more rigid material that resembles skin in appearance only.

Advantages

From the description above, a number of advantages of my football shaped double breast model become evident:

(a) Simultaneous tactile comparison is easily achieved with the double breast model by placing one hand on each end of the model.

(b) Simultaneous tactile comparison can be experienced between a tumor free end of the model and an opposite end with a single simulated tumor or a plurality of simulated tumors of varying densities.

(c) Simultaneous tactile comparison can be experienced between simulated tumors of different density or size by placing them on opposite ends of the model in predetermined or marked locations.

(d) Through the various attachment combinations possible between the separate flexible enclosure containing simulated tumors, the semi-rigid core area and the simulated skin, every tumor can be simulated in location, size and tactile sensation.

(e) The presence of a semi-rigid area in the center of the model simulates the denser muscle tissue, underlying bone structure and connective tissue and stiffens the model.

(i) The presence of a semi-rigid area in the center of the model can reduce the overall weight.

(g) The semi-rigid core area can be increased in size and the simulated adipose tissue decreased proportionally to create the desired feel and weight for an embodiment as a sport ball.

(h) Because of its unique football-like shape and the many natural combinations possible on the respective ends, the double breast model has value as a sex education device, promotional and novelty item.

### OPERATION

### FIGS. 1, 2, 3, 4, 5, 6, 7

The standard methods of palpating tumors will apply to the double breast model and would be especially suited to the models depicted in FIGS. 4 and 5 wherein the center contains a semi-rigid core area 22. Using the inner portions of the ends of the three middle fingers a circular motion should be applied with varying amounts of pressure. The circular motion should cover an area about the width of the middle or forefinger and should proceed in a directional manner designed to cover the entire breast area through a series of circular motions. Each circular motion sequence should be performed by moving the sequence approximately ½-inch each time until the examination has covered all of the required breast areas. In addition, the thumbs can be utilized to press the tissue comprising the breast model against the side of the forefingers wherein the broad part of the thumbs can be used to feel for simulated tumors 23, 24, 25, 26.

The double breast models shown in the FIGS. 2, 3, 4, 5, and 6 will allow the above methods of palpation to be conducted with both hands in a simultaneous fashion. The simultaneous methods of palpation would facilitate tactile comparison and provide a base point from which to judge one sensation against another. If desired, the double breast model could be constructed with a mounting system to steady the model by installing a socket or hole in the model in which a dowel or rod connected to a base might be inserted. This could be easily achieved with the double breast models shown in FIGS. 4, 5 and 6 wherein there is a semi-rigid core area 22 into which a socket could be firmly set.

The double breast model in FIG. 6 shows a large semi-rigid core area 22 surrounded by a proportionally reduced simulated adipose tissue 21 area. The semi-rigid core area 22 can be comprised of an air chamber or inner tube, which could be inflated to the desired pressure to achieve the degree of softness or hardness necessary for the desired use.

When the simulated adipose tissue 21 comprises a smaller portion of the model it will become a lightweight item that can be readily used as a sport ball or for promotional purposes. The FIG. 6 embodiment shows a medium density tumor 23 situated within one end of the model demonstrating its ability to serve two purposes: as a double breast model promoting awareness of breast cancer and retain a weight and balance of a sport ball. If the simulated adipose tissue 21 is a polyester-fill material compressed by the simulated skin 20 the embodiment would lend itself readily to promotional use due to its economical construction and would still retain a lifelike feel.

The double breast model in FIG. 7 shows an embodiment where the semi-rigid core area 22 covers the entire center area of the model and is covered with only the simulated skin 20 or may have the appearance of a skin covering. This embodiment, like the one in FIG. 6, would be used mainly as a sport ball and promotional device but would only be capable of containing a tumor on or near the surface of the skin 25.

Conclusion, Ramifications and Scope

The oval shape has been recognized as an aesthetically pleasing and popular shape providing success in advertising for many years. Ford Motor Company®, Peterbilt Trucks®, KIA®, Toyota®, Lexus®, Isuzu®, Subaru®, Mazda®, Nissan®, Oldsmobile®, Geo®, Amalie Oil Co.®, Enco Oil®, Esso Oil®, Conoco Oil®, Amoco Oil®, American Oil®, Standard Oil®, Pennzoil®, Amzoil®, STP®, DuPont®, Pfizer®, Merck®, Church's Chicken®, A&W Root Beer®, Tyson Foods®, IGA Supermarkets®, Jack Daniels Whiskey®, Heineken®, Foster's Lager®, Bud Light®, Sierra Club® and Kiwanis International®, are just a small number of well known companies, products and organizations whose logos are memorable due to their use of the oval shape for promotional purposes as a major part of their logo. A two-word search consisting of “oval logo” on the Google Internet search engine produced over 58,000 occurrences of products with oval logos. Whether two-dimensional or three-dimensional like the double breast model of this invention, the oval shape has been a proven promotional success for many years. A double breast model in the unique, oval, football-like shape will have the combined attributes of serving promotional clinical, recreational and educational needs. Accordingly, the reader can see that the double breast model described herein has the additional advantages in that:

a it becomes a multi-use item, which combines an aesthetically pleasing shape, (oval and symmetrical), a likeness of a sport ball, and double breast model in a way that can transcend the use of any of these items in their normal singular existence;

it permits the simultaneous comparison of the feel and texture of a tumor free breast on one end of the model and a breast with a tumor or multiple tumors on the other;

it permits the simultaneous comparison of the feel and texture between the various types of tumors that one may choose to place on opposite ends of the model;

it can be successful in bridging the gap between the clinical intrusive nature of self-examination teaching devices in the prior art and the home environment by means of the less offensive double breast model's unique shape and its identification as a novelty item and sport ball;

it can display the different colors of skin tones as they naturally occur among the various ethnic groups on opposite ends of the double breast model for easy comparison;

it can display the various combinations possible between the areolas and nipples in size, shape and color as they occur in nature on the opposing ends of the double breast model to allow comparison;

it can be a more successful sex education device because of it's less offensive football-like shape than the single breast model.

Although the descriptions above contain many specifics, they are not intended to limit the scope of the invention but merely provide some illustrations of the presently preferred embodiments of the double breast model. For example, the simulated skin, the simulated adipose tissue, the semi-rigid core area, the simulated tumors, may vary in size, composition, and proportion to each other or the overall size of the model need not be in any relation to that as occurs in nature, The double breast model may incorporate laces or markings as reference points.

Thus the scope of the invention should be determined by the appended claim and their legal equivalents, rather than by the examples given.

I claim:

1. A double breast model comprising breasts arranged with a nipple and its areola on each end and with the backs of the breasts joined in a continuous configuration to form a shape similar to a rugby ball or football.

2. The double breast model of claim 1 further comprising the interior containing a first means for simulating adipose tissue and the exterior covering comprises a second means for simulating skin.

3. The double breast model of claim 2 further including a third means for simulating a tumor contained within the first means for simulating adipose tissue.

4. The double breast model of claim 2 further including a separate flexible enclosure filled with a material of the first means for simulating adipose tissue in addition to the remaining area filled with a material of the first means surrounded by the second means for simulating skin.

5. The double breast model of claim 4 further including a plurality of the third means for simulating tumors of varying densities and sizes are disposed on the surface of said flexible enclosure, within the first means simulating adipose tissue and the second means simulating skin or in removable placement.

6. The double breast model of claim 2 further including a fourth means for stiffening the core of the model and simulating underlying skeletal, muscle and connective tissue.

7. The double breast model of claim 6 further including a third means for simulating a tumor within the first means for simulating adipose tissue.

8. The double breast model of claim 7 wherein the third means for simulating a tumor is suspended in position with fine diameter spun polyester line material.

9. The double breast model of claim 7 further to include a separate flexible enclosure filled with a material of the first means for simulating adipose tissue in addition to the remaining area filled with a material of the first means surrounded by the second means for simulating skin.

10. The double breast model of claim 9 further including a plurality of the third means simulating tumors of varying densities and size disposed on the surface of said flexible enclosure, within the first means for simulating adipose tissue, second means for simulating skin or on the surface of the fourth means for stiffening the model and simulating underlying skeletal, muscle and connective tissue or in removable placement.

11. The double breast model of claim 10 wherein the fourth means for stiffening the model and simulating underlying skeletal, muscle and connective tissue incorporates a mounting mechanism for placement on a stand.

12. The double breast model of claim 2 wherein the fourth means for stiffening the model and simulating underlying skeletal, muscle and connective tissue substantially fills the majority of the center of the model.

13. The double breast model of claim 12 wherein the fourth means is an air chamber.

14. The double breast model of claim 12 further comprising a third means for simulating a tumor.

15. The double breast model of claim 14 further including a plurality of the third means for simulating tumors of varying densities and size disposed on surface of second means for simulating skin, within the first means for simulating adipose tissue, on the surface of the fourth means for simulating the skeletal, muscle and connective tissue or on the surface of a separate flexible enclosure.

16. The double breast model of claim 1 wherein the first, second and fourth means are comprised of the same resilient material.

17. The double breast model of claim 16 wherein a third means for simulating tumors can be removably placed.

18. A method of training a person to palpate a breast for detection of tumors on a double breast model containing a minimum of one tumor, comprising the steps of:
a. applying varying amounts of pressure in a predetermined pattern of palpation with both hands on respective ends of the double breast model to produce a sensation simulating the presence of a tumor, and
b. checking for the marked location and description of a simulated tumor to verify each tactile sensation experienced by the respective left or right hand,
whereby simultaneous comparison of tactile sensations in each hand can be achieved between the respective ends of said double breast model wherein each end may or may not possess a tumor or tumors.
